(19) United States
(12) Patent Application Publication
(10) Pub. No.: US 2004/0078674 A1
(43) Pub. Date: Apr. 22, 2004

(54) Methods and apparatus for generating functional test programs by traversing a finite state model of an instruction set architecture

(75) Inventors: Richard S. Raimi, Austin, TX (US); Fadi Aloul, Dearborn, MI (US)

Correspondence Address: PRIEST & GOLDSTEIN PLLC, 5015 SOUTHPARK DRIVE, SUITE 230, DURHAM, NC, 27713-7736, US

(73) Assignee: BOPS, Inc., Chapel Hill, NC

(21) Appl. No.: 10/116,221

(22) Filed: Apr. 4, 2002

Related U.S. Application Data
(60) Provisional application No. 60/281,523, filed on Apr. 4, 2001.

(51) Int. Cl. G06F 11/00

(52) U.S. Cl. 714/33

(57) ABSTRACT

The present application addresses a new approach to applying formal verification techniques to automatically generate intelligent test vectors that cover specific architectural properties. In one aspect, this approach uses a bounded model checking with satisfiability solving to traverse a finite state transition system that represents an instruction set architecture, in order to generate high quality test vectors. The experimental results, performed on a BOPS VLIW DSP core consisting of an array of four pipelined processors, demonstrate that the technique can advantageously handle large industrial designs. The proposed technique has several advantages. Designers can specify architectural states using Boolean variables and generate test vectors for any state that is reachable, within the compute resources available or prove that the state is unreachable within the given bound k. This technique also allows the designer to restrict specific states from being covered by the test. In a general way, this technique allows the user to describe constraints an instruction sequence should obey and then to generate sequences which obey them. The approach is also able to detect the shortest set of instructions that reaches a given architectural state and satisfies user supplied constraints.

The present invention claims the benefit of U.S. Provisional Application Serial No. 60/281,523 entitled “Methods and Apparatus for Generating Functional Test Programs by Traversing a Finite State Model of an Instruction Set Architecture” filed Apr. 4, 2001 which is incorporated by reference herein in its entirety.

### FIELD OF THE INVENTION

The present invention relates generally to improved methods and apparatus for more efficiently testing digital hardware. More particularly, the present invention provides advantageous techniques for testing large scale designs, such as digital hardware that implements a set of processor instructions.

### BACKGROUND OF THE INVENTION

Verification may be defined as the process of detecting errors in designs or determining that there are none. As the size and complexity of hardware designs increase and their time to market decreases, design validation by way of case by case testing becomes more and more inadequate. Formal verification techniques, which provide mathematically sound proofs about design properties are increasingly being turned to. However, as addressed in greater detail below, formal verification often suffers from capacity limitations. A number of approaches have been tried.

By way of example, in the 1980s, techniques known as model checking began being applied to state transition systems. A well known publication describing model checking is Clarke, Emerson and Sistla, “Automatic Verification of Finite-State Concurrent Systems using Temporal Logic”, in ACM Transactions on Programming Languages and Systems, 8(2), April, 1986. This paper is incorporated by reference herein in its entirety. Model checking refers to any of a set of algorithms for traversing the state space of a state transition system in order to determine if some specification of that system's behavior, written in what is called a temporal logic, is true or false. A temporal logic is a mathematically precise specification language in which one can describe a state transition system's behavior over time. In model checking, a given state transition system is explored by state traversal techniques to determine if the system is a model of a given formula in a temporal logic, i.e., if that formula is always true for that system. State traversal refers to finding which states are reachable from other, given states, given a description of the transition relation of the system.

Early model checking systems used explicit state graph traversal techniques. In other words, the state transition graph of the system was explicitly enumerated from the transition relation of the system, and this graph was then stored in a computer's memory and manipulated. -In the late 1980s and early 1990s, techniques relying on binary decision diagrams (BDDs) became prevalent. BDDs are described in “Graph Based Algorithms for Boolean Function Manipulation”, by Bryant, in IEEE Transactions on Computers, 35(8), 1986. BDD-based state traversal methods are known as symbolic, or implicit state traversal methods, and are described in “A Computational Theory and Implementation of Sequential Hardware Equivalence”, by Pixley in DIMAC 3 Series in Discrete Mathematics and Theoretical Computer Science, Vol. 3, 1991, pp. 293-320. These papers are incorporated by reference herein in their entireties. BDDs provide a means of storing a Boolean function as an incomplete binary tree such that redundant information is eliminated. For many functions of interest, BDDs provide a very compact means of storing the truth table for that function, using memory space much smaller than the explicit truth table would require. Symbolic state traversal using BDDs is carried out by having a BDD representation of the characteristic function of the transition relation of the system, and manipulating that BDD to find sets of states reachable from given sets of states. Once states are encoded with Boolean variables, a set of states may be represented by a Boolean function, the characteristic function of that set. Thus, manipulation of sets of states can be carried out by manipulation of Boolean functions, and, in turn, this can be carried out by manipulation of BDDs, since well known algorithms exist to perform Boolean operations, such as conjunction, disjunction, and the like, on BDDs, yielding new BDDs as a result. These Boolean operations can be equated to operations on sets. For instance, the conjunction, or AND, operation on characteristic functions of sets is equivalent to the intersection of those sets.

State traversal using BDDs resulted in an increase of several orders of magnitude in the size of state transition systems which could be traversed, where size is measured in terms of the number of states. While BDDs offer advantages over explicit search for breadth-first search techniques, the size of the state spaces that can be explored is still too limited for many applications. To circumvent this barrier, a search method known as bounded model checking was recently created. This model is described in “Symbolic Model Checking using SAT Procedures instead of BDDs”, proceedings of the Design Automation Conference, June 1999 which is incorporated by reference herein in its entirety. This method has been successfully applied to state reachability checking, i.e., checking whether a member of one set of states is reachable from a member of another set of states. In bounded model checking, the transition relation is kept as a Boolean formula which one unfolds over a finite number of time steps by making time-stamped copies of it, i.e., changing the variable names in each copy to indicate valuations of the variables at discrete time points. In addition, a time stamped copy of the characteristic function of a starting set of states is created, a time stamped copy of the characteristic function of the final set of states to be reached is created, and these functions are ANDed with the unfolded transition relation. The entire formula including the predicates for the starting and ending sets of states, and the unfolded transition relation, is then utilized as an input to a satisfiability solving tool, a tool that determines if a Boolean function has or has not a satisfying assignment. Assuming the transition relation was unfolded for ‘k’ steps, the formula given over for satisfiability solving represents all possible sequences of state transitions of that length. If the satisfiability solver determines the formula is unsatisfiable, it means that a sequence of transition from the start set of states to the end set of states in ‘k’ time steps is impossible in that state transition system. If the satisfiability solver finds that there is a satisfying assignment, it returns it, and that assignment is a sequence of state transitions leading from a single member of the set of start states to a single member of the set of ending states in ‘k’ time steps. If the set of start states is the designated set of initial states of the transition system, then one has proven the reachability of that member of the set of end states.

The main advantage of bounded model checking over BDD-based model checking is the larger number of state variables that can be manipulated. The disadvantage is that there is no easy, efficient way to check specifications which do not involve simple reachability. Additionally, the method is incomplete, in that a simple reachability check of a finite length cannot determine total lack of reachability, in the absence of knowledge about what is known as the diameter of the state space, that being the minimum number of state transitions such that any state may be reached from an initial state in that number of state transitions, or less. However, despite these drawbacks, bounded model checking represents a great step forward for the problem domains where simple state reachability is all that is needed.

Implementations of bounded model checking usually work as follows. A state transition system is described as a set of Boolean functions, each of which describes how a certain state variable is updated. In such a system, two copies of the set of state variables are made where one set is labeled as the present state and the other as the set of next state variables. One can then define a set of Boolean functions that characterize the transition relation of each state variable. Each such function is the XNOR of a next state variable and its associated transition function. The characteristic function of the transition relation of the entire system is then defined as the product of the functions characterizing the individual state variable transition relations. This characteristic function of the system's transition relation returns true if and only if its argument, an assignment to present state, next state and input variables, represents a valid transition which the system can produce. So far, this is the method used for BDD based model checking as well, except that the functions are kept in BDD format whereas in bounded model checking with SAT, they are kept as Boolean formulae. In bounded model checking, if one then desires to check paths of length ‘k’, then ‘k’ copies of the transition relation are created, each copy having its variables renamed to indicate successive time steps. Recalling that each individual transition relation has in it only one next state variable, the variable names in each copy of the transition relation are changed so that the names of each next state variable indicate a time point one time step in advance of all the present state and input variable time stamps. These time stamped copies of the individual transition relations are then ANDed together, and time stamped versions of the predicates characterizing the set of beginning and ending states are also ANDed together. These predicates characterizing the beginning and ending sets of states would be time stamped to the first and the k-th time step, respectively. The resulting Boolean formula is then checked for satisfiability. A satisfying assignment may then be decoded to yield the input valuations on each of the k discrete time steps that would drive the system from a given member of the starting states, also decoded from the satisfying assignment, to a given member of the ending, or final states which are again, decoded from the satisfying assignment.

It is often desirable to model certain constraints operating as invariants in a state transition system. The way this is typically accomplished is as follows. When unfolding the transition relation, as explained above, for ‘k’ time steps, ‘k’ time stamped copies of the predicates assumed to be invariants are also created, and these are ANDed with the unfolded transition relation and the time stamped predicates for the beginning and ending states. Any satisfying assignment then found for this formula is guaranteed to be a state sequence in which, in every state, the invariants are obeyed.

Most state transition systems are useful as abstractions only when initial states are defined. This adds meaning to the concept of a “reachable” state, the latter being a state that can be reached from some initial state, of which there may be many, by some number of valid state transitions.

The notion of traversing a finite state transition system in order to find appropriate tests for a design has been proposed previously. Dill, Ho, Yang and Horowitz outlined such a technique in “Architecture Validation for Processors”, published in ACM's ISCA, in 1995, as did Iwashita, Kowatari, Nakata and Hirose, in “Automatic Test Program Generation for Pipelined Processors”, in the Proceedings of the International Conference on Computer Aided Design, 1994 both of which are incorporated by reference herein in their entirety. The latter authors proposed a technique that used BDD based techniques for exploring state spaces, in order to come up with a sequence of input assignments that would result in a complete tour of a state space. Here, complete means in the sense of visiting each state at least once. In this paradigm, datapath and memory elements were stripped from a higher level, register transfer language (RTL) description of a digital hardware design, and the resulting design, representing pure control logic, was interpreted as a finite state machine. Dill, Ho, Yang and Horowitz used the Murfi model checking system, which implements explicit search, to explore the state space.

A method for generating assembly language programs that test a subcircuit inside a processor, by creating a finite state transition system in which circuit states, i.e., valuations of latch elements in the circuit, are related, by hand, to execution of certain instruction types, was outlined by Benjamin, Geist, Hartman, Mas, Smeets, and Wolfstahl, in “A Study in Coverage-Driven Test Generation”, published in the Proceedings of the Design Automation Conference, June, 1999 which is incorporated herein in its entirety. The test generator in use in “A Study in Coverage-Driven Test Generation” is of the general type described in U.S. Pat. No. 5,202,889 which is also incorporated by reference herein in its entirety. Such test generators create tests for a specific ISA based on user input specifying which opcode types are to populate the test program, possible sequences for those opcodes, and possibly constraints on operands or targets of the opcodes or on the nature of the sequences that the user supplies.

The overall method in “A Study in Coverage-Driven Test Generation” differs from that of the present invention in at least the following respects:

1. The study method generates tests for covering states within a subcircuit within a processor, instead of for the whole processor.

2. The study method utilizes, as does the Dill and Ho method, the Murfi model checker, and thus uses explicit search for state space traversal rather than the technique of SAT (satisfiability solving)-based bounded model checking.

3. Features of the instruction set architecture are not modeled directly, rather valuations of circuit latches are associated with architectural features only indirectly, by being associated with instructions.

The paper “Micro Architecture Coverage Directed Generation of Test Programs” by Ur and Yadin, of IBM-Haifa, published in the Proceedings of the Design Automation Conference in June, 1999, which is incorporated by reference herein in its entirety, represents an approach in which the traversal of the finite state model to find a state sequence of interest is not done via SAT-based bounded model checking as it is in the present method, but rather by BDD-based traversal methods. This is an important difference as it means that the Ur et al. implementation cannot operate on models of entire processors, and certainly not on arrays of multiple processors as the present SAT-based method can. In this regard, it is noted that the Ur et al. paper addresses a single, arithmetic unit within a processor. Fixed point arithmetic units, such as the one described in that paper, are usually the simplest of the functional units within a modem processor, and it takes far fewer variables to represent their features and their instruction types than it does to represent the features and instruction types of an entire processor. BDD-based, or explicit search based model checking techniques are presently limited to such small sized models.

On the other hand, the method of the present invention, using SAT-based bounded model checking, is robust enough to model, and therefore to find tests for, entire processors. As further evidence of this difference, it is noted that the authors of the paper “Micro Architecture Coverage Directed Generation of Test Programs” claim to generate tests that reach each reachable state in their finite state transition system. This all encompassing approach is only desirable for small systems, as the number of tests needed to cover every architectural state of a model of a processor would overwhelm any typical real world computer network set up for simulation of these tests.

The techniques used in the prior art, of explicit state exploration (holding states in linked lists, or hash tables, and simulating to find states reachable from others) or of implicit state exploration using binary decision diagrams (BDDs) are quite often defeated by the state explosion problem, which is the problem that the reachable state space of a design quickly becomes exponential in the number of state variables used to encode states. In contrast, the techniques of bounded model checking provide a robust state exploration method that can handle much larger state spaces, and the present invention is believed to provide the first method that utilizes these techniques in processor test generation. More details of bounded model checking, including details on using it for state reachability checking, can be found in the Ph.D. Thesis of Richard Raimi, “Environment Modeling and Efficient State Reachability Checking”, University of Texas, December, 1999 which is incorporated by reference herein in its entirety.

### SUMMARY OF THE INVENTION

While significant work has been done, it will be recognized that various problems remain and that it will be highly advantageous to provide verification techniques applicable to a much higher level of abstraction, such as that of an architectural definition of a design. The prior art described above was typically used on sub-circuits within a processor, and produced test vectors that were sequences of valuations on the physical inputs of a digital circuit. By contrast, the present invention produces instruction opcodes to be stored in an instruction memory in order to later be fetched and executed by a processor. Further, the prior art described above was also confined to use on relatively small subcircuits of a modem processor. In another aspect of the present invention, methods in accordance therewith can be utilized to generate tests for complete processor designs, and even for arrays of multiple processors.

In one embodiment of such a method, a finite state transition system is set up that models an instruction set architecture (ISA) of interest and then state space traversal techniques that use Boolean satisfiability solving are used to find sequences of state transitions of interest within that finite state transition system. The description of these state sequences, and of any constraints that are obeyed in the sequences, is then transformed into an assembly language test program that can be run on either a hardware or software implementation of the ISA in order to determine correctness of the implementation.

Among its other aspects, the present invention may be usefully employed to generate, in an automated way, the special comer cases reaching hard to imagine architectural states, and this method enables this to be done for large designs. Simplification of the generated prepositional formulae may ensue and it will also be possible to generate longer test vectors, specifically by concatenating multiple instruction sequences as addressed further below.

These and other advantages of the present invention will be apparent from the drawings and the Detailed Description which follow below.

### BRIEF DESCRIPTION OF THE DRAWINGS

FIG. 1 is a block diagram of a two by two processor array which may be modeled utilizing the techniques of the present invention;

FIG. 2 is a more detailed block diagram of a two by two processor array;

FIG. 3 is an overall flow diagram of a method in accordance with one embodiment of the present invention;

FIG. 4 illustrates various aspects of the creation of a state transition system representing a given ISA;

FIG. 5 illustrates further steps in defining the state transition system of FIG. 4;

FIG. 6 illustrates procedures for creating a test case once a state transition system modeling the ISA has been defined;

FIG. 7 illustrates a concatenation of state sequence which may be advantageously utilized when a SAT-based bounded model checking method fails to produce a result with the available compute resources;

FIG. 8 illustrates a further embodiment of a process in accordance with the present invention;

FIG. 9 illustrates an exemplary output of the process of FIG. 8; and

FIGS. 10 and 11 are tables of experimental test results.

### DETAILED DESCRIPTION

As addressed above, the typical prior art practices for verifying that processor designs function correctly are either to simulate a design using test patterns that are created either by hand or by some automated functional test program generator. With available compute resources, however, it is literally impossible to simulate enough test cases to confirm that the design behaves correctly in each of its states, under all possible operating conditions in each state. Therefore, processor design verification efforts usually are focused on directed tests that target specific architectural features, hoping to find error conditions with a random mix of data. It can be a laborious task to find the instruction combination that brings about the architectural state in which a given set of architectural features are enabled. Thus, it is of enormous benefit to have techniques for automatically specifying and then realizing the goals of functional tests, in terms of reaching architectural states of interest with an automatically generated test pattern. The present invention eliminates what is at present a large, by-hand effort and replaces it with an automated process. To this end, the present invention provides techniques to automatically structure test cases in such a way that processor designs are put into specific architectural states, or specific sequences of such states. The present invention is robust, meaning that it can handle systems, such as arrays of multiple processors, that are of increasing interest to industry.

One presently preferred exemplary array of processors is the ManArray which is described more fully in U.S. patent application Ser. No. 08/885,310 filed Jun. 30, 1997, now U.S. Pat. No. 6,023,753, U.S. patent application Ser. No. 08/949,122 filed Oct. 10, 1997, U.S. patent application Ser. No. 09/169,255 filed Oct. 9, 1998, U.S. patent application Ser. No. 09/169,256 filed Oct. 9, 1998, U.S. patent application Ser. No. 09/169,072 filed Oct. 9, 1998, U.S. patent application Ser. No. 09/187,539 filed Nov. 6, 1998, U.S. patent application Ser. No. 09/205,558 filed Dec. 4, 1998, U.S. patent application Ser. No. 09/215,081 filed Dec. 18, 1998, U.S. patent application Ser. No. 09/228,374 filed Jan. 12, 1999 and entitled “Methods and Apparatus to Dynamically Reconfigure the Instruction Pipeline of an Indirect Very Long Instruction Word Scalable Processor”, U.S. patent application Ser. No. 09/238,446 filed Jan. 28, 1999, U.S. patent application Ser. No. 09/267,570 filed Mar. 12, 1999, U.S. patent application Ser. No. 09/337,839 filed Jun. 22, 1999, U.S. patent application Ser. No. 09/350,191 filed Jul. 9, 1999, U.S. patent application Ser. No. 09/422,015 filed Oct. 21, 1999 entitled “Methods and Apparatus for Abbreviated Instruction and Configurable Processor Architecture”, U.S. patent application Ser. No. 09/432,705 filed Nov. 2, 1999 entitled “Methods and Apparatus for Improved Motion Estimation for Video Encoding”, U.S. patent application Ser. No. 09/471,217 filed Dec. 23, 1999 entitled “Methods and Apparatus for Providing Data Transfer Control”, U.S. Patent application Ser. No. 09/472,372 filed Dec. 23, 1999 entitled “Methods and Apparatus for Providing Direct Memory Access Control”, U.S. patent application Ser. No. 09/596,103 entitled “Methods and Apparatus for Data Dependent Address Operations and Efficient Variable Length Code Decoding in a VLIW Processor” filed Jun. 16, 2000, U.S. patent application Ser. No. 09/598,567 entitled “Methods and Apparatus for Improved Efficiency in Pipeline Simulation and Emulation” filed Jun. 21, 2000, U.S. patent application Ser. No. 09/598,564 entitled “Methods and Apparatus for Initiating and Resynchronizing Multi-Cycle SIMD Instructions” filed Jun. 21, 2000, U.S. patent application Ser. No. 09/598,566 entitled “Methods and Apparatus for Generalized Event Detection and Action Specification in a Processor” filed Jun. 21, 2000, and U.S. patent application Ser. No. 09/599,980 entitled “Methods and Apparatus for Establishing Port Priority Functions in a VLIW Processor” filed Jun. 21, 2000, as well as, Provisional Application Serial No. 60/113,637 entitled “Methods and Apparatus for Providing Direct Memory Access (DMA) Engine” filed Dec. 23, 1998, Provisional Application Serial No. 60/113,555 entitled “Methods and Apparatus Providing Transfer Control” filed Dec. 23, 1998, Provisional Application Serial No. 60/139,946 entitled “Methods and Apparatus for Data Dependent Address Operations and Efficient Variable Length Code Decoding in a VLIW Processor” filed Jun. 18, 1999, Provisional Application Serial No. 60/140,245 entitled “Methods and Apparatus for Generalized Event Detection and Action Specification in a Processor” filed Jun. 21, 1999, Provisional Application Serial No. 60/140,163 entitled “Methods and Apparatus for Improved Efficiency in Pipeline Simulation and Emulation” filed Jun. 21, 1999, Provisional Application Serial No. 60/140,162 entitled “Methods and Apparatus for Initiating and Re-Synchronizing Multi-Cycle SIMD Instructions” filed Jun. 21, 1999, Provisional Application Serial No. 60/140,244 entitled “Methods and Apparatus for Providing One-By-One Manifold Array (1×1 ManArray) Program Context Control” filed Jun. 21, 1999, Provisional Application Serial No. 60/140,325 entitled “Methods and Apparatus for Establishing Port Priority Function in a VLIW Processor” filed Jun. 21, 1999, Provisional Application Serial No. 60/140,425 entitled “Methods and Apparatus for Parallel Processing Utilizing a Manifold Array (ManArray) Architecture and Instruction Syntax” filed Jun. 22, 1999, Provisional Application Serial No. 60/165,337 entitled “Efficient Cosine Transform Implementations on the ManArray Architecture” filed Nov. 12, 1999, and Provisional Application Serial No. 60/171,911 entitled “Methods and Apparatus for DMA Loading of Very Long Instruction Word Memory” filed Dec. 23, 1999, Provisional Application Serial No. 60/184,668 entitled “Methods and Apparatus for Providing Bit-Reversal and Multicast Functions Utilizing DMA Controller” filed Feb. 24, 2000, Provisional Application Serial No. 60/184,529 entitled “Methods and Apparatus for Scalable Array Processor Interrupt Detection and Response” filed Feb. 24, 2000, Provisional Application Serial No. 60/184,560 entitled “Methods and Apparatus for Flexible Strength Coprocessing Interface” filed Feb. 24, 2000, and Provisional Application Serial No. 60/203,629 entitled “Methods and Apparatus for Power Control in a Scalable Array of Processor Elements” filed May 12, 2000, respectively, all of which are assigned to the assignee of the present invention and incorporated by reference herein in their entirety.

Definitions and Background

An instruction set architecture (ISA) is a set of defined instructions for a certain type of processor, with defined results for executing those instructions and a defined set of constraints that must be present in any implementation of the ISA in order to properly execute its instructions.

A finite state transition system is an abstraction useful for modeling certain real systems of interest. Finite state transition systems are characterized by having a finite set of objects known as states, and the system is considered to be in a certain state at a discrete time point, and is able to transition from some state in the present to some next state at a next time point. A set of rules governs which states may transition to which others. If the particular state transition system has inputs and it need not, then these rules usually involve input valuations. In general, it is possible to represent the states of such a system with assignments to members of a set of Boolean variables which are called state variables, and to write the transition rules as a single, Boolean function over two copies of these state variables, these being a present and next state version of the state variables. This single, Boolean function is called the characteristic function of the transition relation of the system. Quite often, it is simply called the transition relation. If the system has inputs, then the transition relation is defined over three sets of variables, those representing present and next state versions of state variables, and a set representing inputs. Inputs are considered to have only a present and not a next value. Sometimes, a transition relation is defined over a fourth set of variables representing outputs of a system, but that is not of interest to the presently preferred embodiments described herein.

Creating such a state transition system for the purpose of modeling an ISA involves three overall steps. First, defining a set of state variables, where each state variable represents an architectural feature enabled by execution of instructions. A state of the system, then, is defined as a valuation for members of this set, i.e., a listing of which architectural features are enabled or disabled. Second, defining a set of Boolean variables, input variables, where each input variable represents an instruction or a set of instructions or a relationship among instructions. Input variables drive transitions among states. Third, defining a set of Boolean functions, transition functions, over the input and state variables such that whenever that transition function is true, on a next time step a specific state variable becomes true.

It is common to compute the image or preimage of a set of states, these being the set of successor states and predecessor states, respectively, of that given set of states. By such computations, one can calculate the set of reachable states, or one can calculate particular sequences of state transitions that lead to states of interest. The characteristic function of such images and preimages can be computed directly by suitable Boolean operations on the characteristic function of the transition relation of the system.

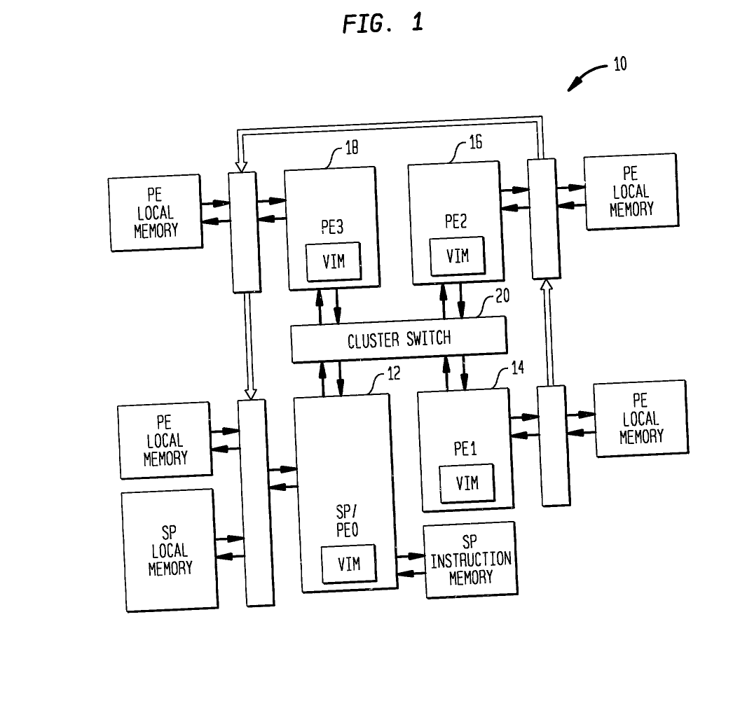

The BOPS 2040 core is a VLIW 32-bit DSP used in embedded applications such as wireless communications, internet multimedia, image processing, and others. As shown in FIG. 1, a core 10 may consist of an array of four processing elements (PEs) SP/PE0 12, PE1 14, PE2 16 and PE3 18 with a single point of control via a sequence processor (SP) that may be advantageously combined with PE0. The PEs and SP are connected via a 32-bit bus through a single-cycle, zero-latency cluster switch 20. Each PE contains five execution units: multiply accumulate unit (MAU), arithmetic logic unit (ALU), data select unit (DSU), load unit (LU), and store unit (SU).

In addition, each PE has its own register file, VLIW instruction memory (VIM), local data memory, and multiple bus interfaces. The instruction set architecture consists of 150+ instructions and efficiently divides functionality across the above five execution units. Most instructions require 1 or 2 execution cycles.

While this architecture is VLIW-based, there are actually no VLIW instructions in its instruction set, rather all instructions are 32-bit instructions. The architecture utilizes an indirect VLIW approach, in that VLIW opcodes are created on the fly by the programmer indicating which of up to 5 instructions in program order should instead of being immediately executed, are to be concatenated and stored in local VLIW instruction memories as VLIW opcodes, for later execution. A 32-bit execute VLIW (XV) instruction can later pull these out and put the machine in VLIW mode, where all functional units on all PEs are executing in parallel. With a facility for what is known as PE masking, all four PEs can be loaded with different VLIWs in their VIMs, or can have the same ones. The core, thus, can be alternately in single instruction, multiple data (SIMD) or multiple instruction, multiple data (MIMD) mode.

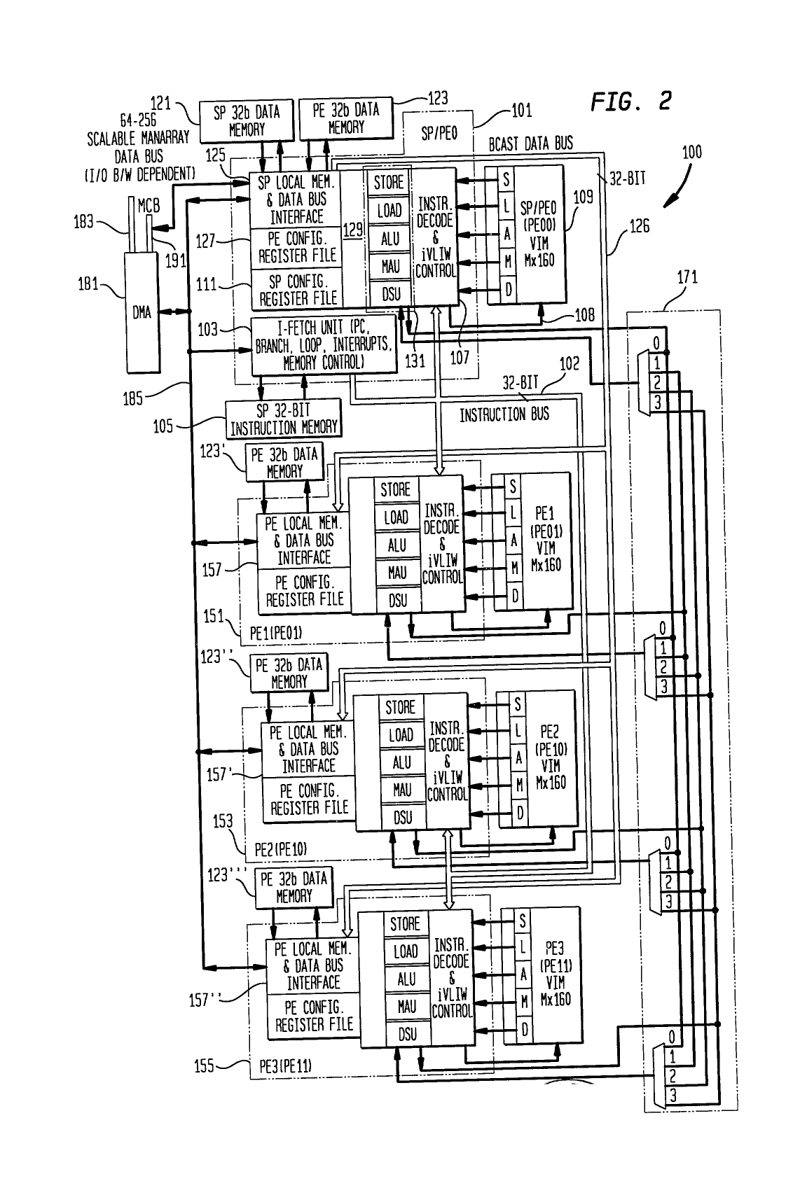

In a presently preferred embodiment of the present invention, a ManArray™ 2×2 iVLIW single instruction multiple data stream (SIMD) processor 100 shown in FIG. 2 contains a controller sequence processor (SP) combined with processing element-0 (PE0) SP/PE0 101, as described in further detail in U.S. application Ser. No. 09/169,072 entitled “Methods and Apparatus for Dynamically Merging an Array Controller with an Array Processing Element”. Three additional PEs 151, 153, and 155 are also utilized to demonstrate improved parallel array processing with a simple programming model in accordance with the present invention. It is noted that the PEs can be also labeled with their matrix positions as shown in parentheses for PE0 (PE00) 101, PE1 (PE01) 151, PE2 (PE10) 153, and PE3 (PE11) 155. The SP/PE0 101 contains a fetch controller 103 to allow the fetching of short instruction words (SIWs) from a 32 bit instruction memory 105. The fetch controller 103 provides the typical functions needed in a programmable processor such as a program counter (PC), branch capability, digital signal processing loop operations, support for interrupts, and also provides the instruction memory management control which could include an instruction cache if needed by an application. In addition, the SIW I-Fetch controller 103 dispatches 32-bit SIWs to the other PEs in the system by means of a 32-bit instruction bus 102.

In this exemplary system, common elements are used throughout to simplify the explanation, though actual implementations are not so limited. For example, the execution units 131 in the combined SP/PE0 101 can be separated into a set of execution units optimized for the control function, e.g. fixed point execution units, and the PE0 as well as the other PEs 151, 153 and 155 can be optimized for a floating point application. For the purposes of this description, it is assumed that the execution units 131 are of the same type in the SP/PE0 and the other PEs. In a similar manner, SP/PE0 and the other PEs use a five instruction slot iVLIW architecture which contains a very long instruction word memory (VIM) memory 109 and an instruction decode and VIM controller function unit 107 which receives instructions as dispatched from the SP/PE0's I-Fetch unit 103 and generates the VIM addresses-and-control signals 108 required to access the iVLIWs stored in the VIM. These iVLIWs are identified by the letters SLAMD in VIM 109. The loading of the iVLIWs is described in further detail in U.S. patent application Ser. No. 09/187,539 entitled “Methods and Apparatus for Efficient Synchronous MIMD Operations with iVLIW PE-to-PE Communication”. Also contained in the SP/PE0 and the other PEs is a common design PE configurable register file 127 which is described in further detail in U.S. patent application Ser. No. 09/169,255 entitled “Methods and Apparatus for Dynamic Instruction Controlled Reconfiguration Register File with Extended Precision”.

Due to the combined nature of the SP/PE0, the data memory interface controller 125 must handle the data processing needs of both the SP controller, with SP data in memory 121, and PE0, with PE0 data in memory 123. The SP/PE0 controller 125 also is the source of the data that is sent over the 32-bit broadcast data bus 126. The other PEs 151, 153, and 155 contain common design physical data memory units 123′, 123″, and 123′″ though the data stored in them is generally different as required by the local processing done on each PE. The interface to these PE data memories is also a common design in PEs 1, 2, and 3 and indicated by PE local memory and data bus interface logic 157, 157′ and 157″. Interconnecting the PEs for data transfer communications is the cluster switch 171 more completely described in U.S. patent application Ser. No. 08/885,310 entitled “Manifold Array Processor”, U.S. application Ser. No. 09/949,122 entitled “Methods and Apparatus for Manifold Array Processing”, and U.S. application Ser. No. 09/169,256 entitled “Methods and Apparatus for ManArray PE-to-PE Switch Control”. The interface to a host processor, other peripheral devices, and/or external memory can be done in many ways. The primary mechanism shown for completeness is contained in a direct memory access (DMA) control unit 181 that provides a scalable ManArray data bus 183 that connects to devices and interface units external to the ManArray core. The DMA control unit 181 provides the data flow and bus arbitration mechanisms needed for these external devices to interface to the ManArray core memories via the multiplexed bus interface represented by line 185. A high level view of a ManArray Control Bus (MCB) 191 is also shown.

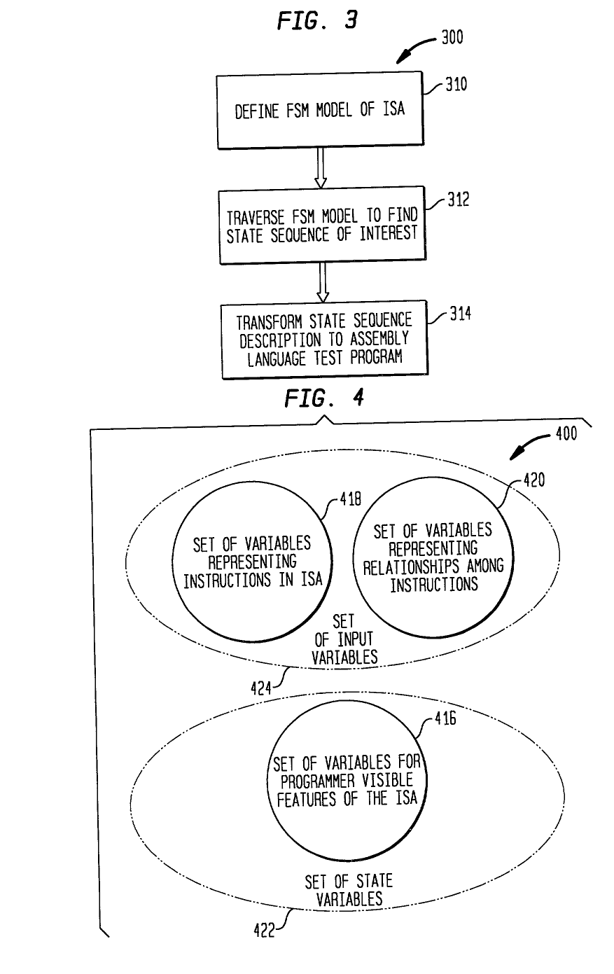

At a high level, a method 300 in accordance with the present invention involves three steps, which are illustrated in FIG. 3:

Defining a state transition system that models an instruction set architecture, step 310 of FIG. 3,

Traversing that state transition system using SAT-based bounded model checking to find state transitions that reach architectural states of interest in a designated sequence obeying certain designated constraints, step 312, FIG. 3, and

Transforming that sequence of states and state transitions and constraints on states and state transitions into an assembly language test program, step 314, FIG. 3.

To implement step 310, the following sets of Boolean variables 400 are defined, as illustrated in FIG. 4:

a set of variables 416 representing programmer visible features,

a set of variables 418 representing instructions, and

a set of variables 420 representing relationships among instructions.

A programmer visible feature is a bit or a Boolean combination of bits in ISA defined registers, or possibly of inputs to such bits. An instruction is an instruction in the given ISA. An example of a relationship among instructions is the target register of one instruction being an operand register for the next.

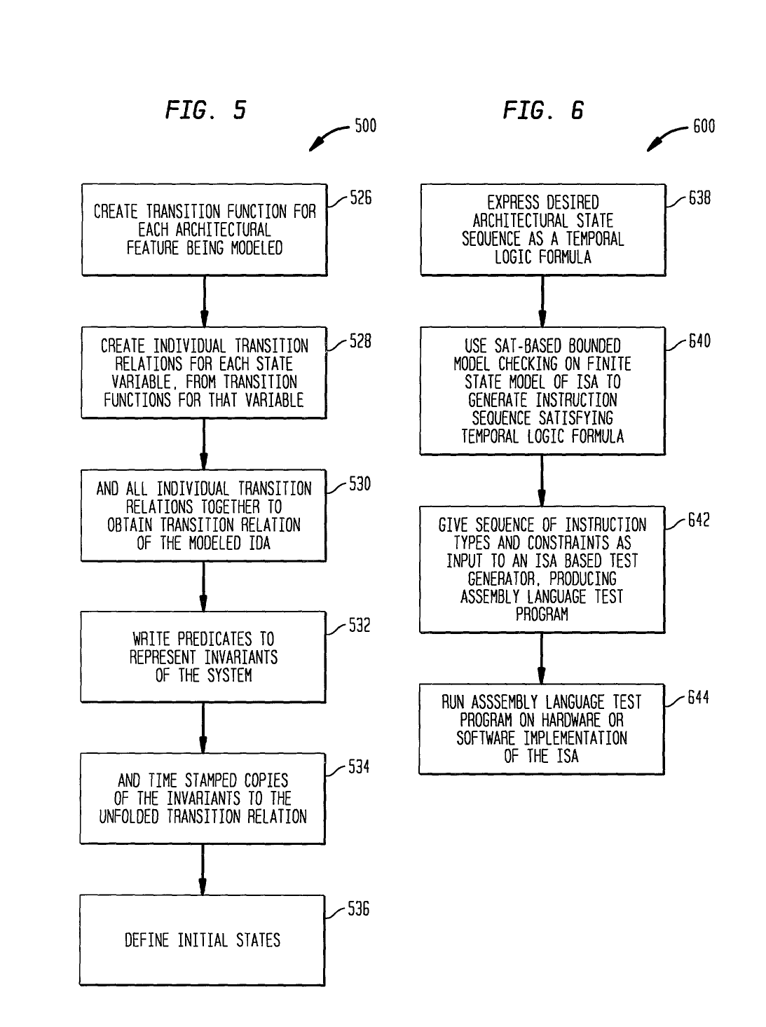

To create a state transition system, one must first identify a set of state variables and define a present and next state variable pair for each of these, and one must identify a set of variables that represent inputs to the system. To create a state transition system representing a given ISA, a set of state variables are chosen to be those representing programmer visible features, such as set 422 of FIG. 4, and the input variables as a set union 424 of the set of variables representing instructions 418, and the set of variables 420 representing relationships among instructions. Steps of a method 500 of defining the state transition system are illustrated in FIG. 5. A transition function is defined for each state variable in step 526. This is done by consulting the written specification for the ISA. These transition functions, when true, indicate that the architectural feature is enabled. The transition functions, of which there will be one for each architectural feature modeled, are written over the present state versions of the variables representing architectural features, as well as the variables representing inputs. The transition relation of the system is created by creating individual transition relations for each architectural feature modeled in step 528, and then by ANDing all of these together to form the transition relation of the entire system in step 530. Note that it is not required that every architectural feature described in an ISA be modeled for this method to work. In general, one can choose to not model certain features and still generate useful tests. The individual transition relations are created in step 528 by XNORing the next state variable for each architectural feature with the transition function for that feature.

In addition, it is usually necessary to write predicates that define constraints on the programming environment of the ISA as in step 532. For instance, for very long instruction word (VLIW) ISAs, it is usually possible to initiate parallel execution of multiple instructions in such a way that multiple instructions may attempt to update the same programmer visible resources at the same time. Thus, an ISA for a VLIW architecture may specify certain rules of priority such that it is clear which instructions are enabled to make updates under those conditions. Such resource conflicts can be expressed as Boolean predicates. Another example of a constraint an ISA may implement is that an ISA may have a supervisor and user mode of operation, and certain instructions may be disabled in user mode. This, too, can be written as a predicate. In this case, it would be considered an invariant of the system, and the predicate should be true in every state. Such constraints are ANDed together with the unfolded transition relation of the system in step 534, to insure the production of state sequences obeying the constraints. Lastly, it remains to identify initial states of the system, in step 536. For a state transition system representing an ISA, this is usually defined as the state in which all internal instruction pipelines are empty. The initial states predicate is ANDed in with the unfolded transition relation as the beginning set of states, whenever it is desired to determine reachability of a state from initial states.

FIG. 6 outlines a process 600 of creating a test case once a state transition system modeling the ISA has been defined. Once such a state transition system, along with assumed constraints has been created, one can specify the types of state sequences one would like to determine are possible as formulae in a temporal logic as in step 638, and use SAT-based bounded model checking techniques, as in step 640, to find examples of such state sequences, or, alternatively, prove that these are impossible. For any state sequence that is returned by the Boolean satisfiability-solving tool, such a sequence may be considered to be an instruction sequence template. It is a template and not a complete instruction sequence because in the general case, not all aspects of the instruction opcodes will be specified, because not all of these will have been modeled with the Boolean variables used for representing instructions and relationships among instructions. Rather, there will be a degree of freedom in choosing among various instructions and among various parameters for these instructions, such that any of these choices will result in the same architectural states being reached. Next, in step 642, the instruction sequence template and the constraints on relationships among instructions are transferred into a specialized test generation program, a test program generator specific to the given ISA that generates assembly language test programs based on user specified sequences of opcode types and user specified constraints. Such a test program generator then, in step 644, instantiates fully specified opcodes into the instruction sequence template, in order to create an executable, assembly language test program that, when executed on a real hardware or software implementation of the ISA will reach the architectural states of interest.

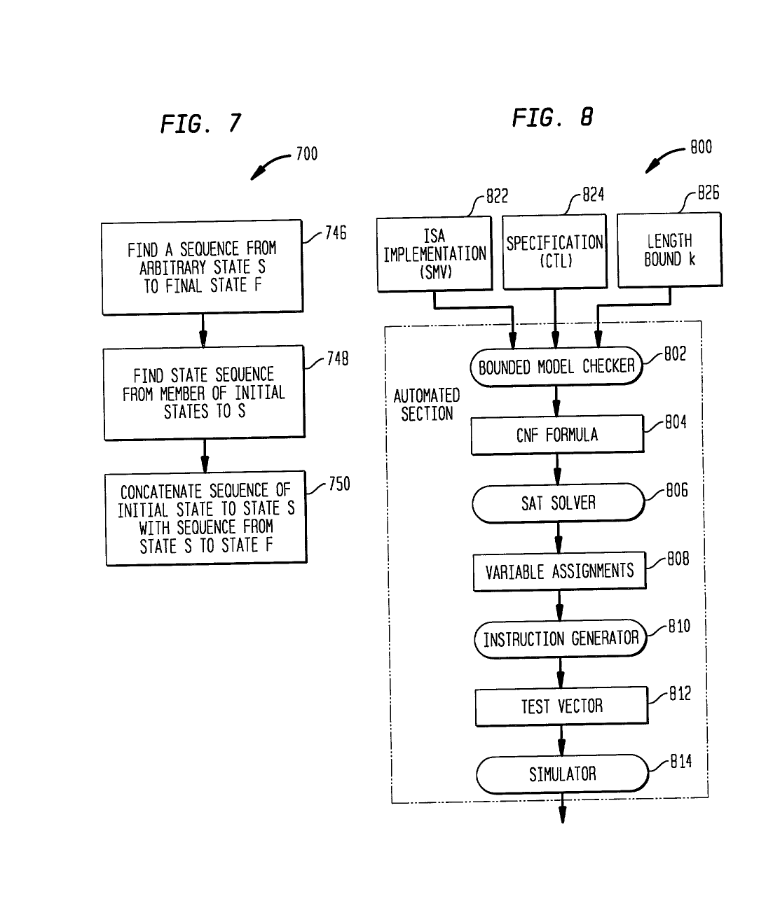

It may occur that the SAT-based bounded model checking method sometimes fails to produce a result with the compute resources available to it. FIG. 7 illustrates a process 700 for addressing this situation. Assuming the goal is to reach some final state F from some initial state, and assuming this is too difficult with available compute resources, one could let the SAT-based bounded model checker find a sequence leading to F from some arbitrary state as in step 746, and then one could attempt to find a sequence from an initial state to S, and in step 748, using the same methods described herein, and then concatenate the two sequences, as in step 750, where the first sequence goes initial state to S, and the second from S to F. This method can be repeated for as many times as necessary until the needed sequence from an initial state to F is found.

As an example of how the basic test generation system outlined in FIG. 3 would operate, let us consider an arbitrary architecture with a corresponding ISA and let us assume this ISA has some instructions that execute in 2 clock cycles, while the rest of the instructions execute in 1 clock cycle. Let us assume this architecture has an internal pipeline with a fetch stage, a decode stage, and up to two execute stages, where the 1 cycle instructions use only the first execute stage, while 2 cycle instructions use both. Let us further assume that certain conflicts over use of compute resources can occur when a 2 cycle instruction is followed by a 1 cycle instruction and both update the same target register. It would certainly be desirable to generate a test situation where a 2 cycle instruction is followed by a 1-cycle instruction, and they do target the same register. How the present method can create such a test pattern automatically is described below.

In the following discussion, the symbol <−> is used to represent the Boolean XNOR operation, ! to represent Boolean negation, & to represent Boolean AND and | to represent Boolean OR. A total of eight state variables are defined: two for representing each of the fetch, decode, and the two execute stages of the pipeline, respectively. Let us define A and B endings for these pairs of variables, and call the two variables representing the fetch stages of the pipeline FA and FB, the two for decode DA and DB, the two for the first execute stage E1A and E1B, the two for the second execute stage E2A and E2B. The reason two variables are needed for each pipeline stage is that there are three possibilities for each pipeline stage: (1) it holds a 1-cycle instruction, (2) it holds a 2-cycle instruction, or (3) it is empty. The empty condition is denoted as the A and B pair of variables being (0,0), the condition where they hold a 1-cycle instruction as being the valuation (1,0), and the condition where they hold a 2-cycle instruction as being (0,1), where the first value within the parentheses is the value of the A member of the pair, the second the valuation of the B member. The fourth possibility, (1,1), we consider illegal, and will construct our state transition system such that it never occurs in a reachable state.

We can model the set of all 1 cycle instructions with a Boolean variable, which we shall call I1, and the set of all 2 cycle instructions with a Boolean variable which we shall call I2. These are input variables. We will define a third input variable, N, to represent non-deterministic choice, and will show how it is used shortly.

We next define an invariant for the system, a constraint, C, such that

C=! (I1 & I2)

This constraint says that it is impossible for inputs I1 and I2 to be true at the same time. This will prevent us from ever having a state variable pair evaluate to (1,1).

We can define the transition function of the fetch pair, FA and FB as

FA=I1,

FB=I2.

The intuition is that FA is true if a 1-cycle instruction is being fetched, FB if a 2-cycle instruction is being fetched. This is consistent with how we have defined the meanings for 1 or 2 cycle instructions existing in a pipeline stage and for that stage being empty, and the constraint, C, insures that FA and FB will never be true at the same time. The transition functions of the decode pair DA and DB are

DA=FA,

DB=FB.

The transition functions for the first execute stage are

E1A=DA,

E1B=DB.

The transition functions for the second execute stage are a bit different. They are

E2A=false

E2B=E1B

We can note that if and only if a 2-cycle instruction is in the first execute stage, will the E1B variable be true, and since the second execute stage should only hold 2 cycle instructions we should never have the E2A variable be true. Lastly, we define a predicate on state and input variables

T=N & !DA & DB & FA & !FB

The variable, T, is true if and only if a 2 cycle instruction is in decode, a 1-cycle instruction is being fetched, and the input variable representing non-deterministic choice, N, is true. We will assume the meaning of N being true is that the 1 and 2 cycle instructions in the pipeline fetch and decode stages have the same target register.

Individual transition relations are then formed from the transition functions, for each of the state variables, where we use a # mark to indicate the next state version of the variable, while the version without the # mark will be considered present state. These individual transition relations are listed as follows:

FA#<−>I1

FB#<−>I2

DA#<−>FA

DB#<−>FB

E1A#<−>DA

E1B#<−>DB

E2A#<−>false

E2B#<−>E1B

We now define the characteristic function of the initial state of the system, which is that all pipelines are empty. This predicate is:

!FA & !FB & !DA & !DB & !E1A & !E1B & !E2A & !E2B

From our knowledge of the pipeline depth, we can realize that it will take at least 4 time steps to get any sort of instruction into the second pipeline stage. We will use indices in square brackets to represent time, starting the count at 0, and we will change the variable names to incorporate the indices, in order to represent the different time points, thus an index of 4 will represent the state reached after a fourth transition of the system. The state we wish to see the system reach at time step 4 is the state where a 2-cycle instruction is in the second execution stage, a 1-cycle instruction in the first and both share the same target register. From our knowledge of how the pipelines work, we can know that if predicate T is true at time 2, i.e., the following time stamped version of T holds:

N[2] & !DA[2] & DB[2] & FA[2] & !FB[2]

then it is going to be the case that the desired condition of a 2-cycle instruction in its second execute stage and a 1-cycle in its first is going to hold at time step 4. So, we can consider the above predicate adequate for designating the final state of the system. We then form the predicate of the unfolded transition relation for 4 time steps, AND that with the appropriate time stamped initial state predicate, and, in addition, AND in time stamped copies of the assumed system constraint, C, for each time point and the time stamped version of T, above. We then obtain the following Boolean formula, which we will call P. Note, as we write out P, that comments are denoted by two slash marks, //.

// first, the initial states predicate time stamped to time 0

!FA[0] & !FB[0] & !DA[0] & !DB[0] & !E1A[0] & !E1B[0] & !E2A[0] & !E2B[0] & N[2] & !DA[2] & DB[2] & FA[1] & !FB[1] & // indicates same target register used

FA[ 1]<−>I1[0] & // now begins the unfolded transition relation

FB[1]<−>I2[0] &

DA[1]<−>FA[0] &

DB[1]<−>FB[0] &

E1A[1]<−>DA[0] &

E1B[1]<−>DB[0] &

E2A[1]<−>false &

E2B[1]<−>ELB[0] &

FA[2]<−>I1[1] &

FB[2]<−>I2[1] &

DA[2]<−>FA[1] &

DB[2]<−>FB[1] &

E1A[2]<−>DA[1] &

E1B[2]<−>DB[1] &

E2A[2]<−>false &

E2B[2]<−>E1B[1] &

FA[3]<−>I1[2] &

FB[3]<−>I2[2] &

DA[3]<−>FA[2] &

DB[3]<−>FB[2] &

E1A[3]<−>DA[2] &

E1B[3]<−>DB[2] &

E2A[3]<−>false &

E2B[3]<−>E1B[2] &

FA[4]<−>I1[3] &

FB[4]<−>I2[3] &

DA[4]<−>FA[3] &

DB[4]<−>FB[3] &

E1A[4]<−>DA[3] &

E1B[4]<−>DB[3] &

E2A[4]<−>false &

E2B[4]<−>E1B[3] & // end of unfolded transition relation

!(I1[0] & I2[0]) & // next 4 lines are the constraints, C, time-stamped on each step

!(I1[1] & I2[1]) &

!(I1[2] & I2[2]) &

!(I1[3] & I2[3])

If we use Boolean satisfiability solving techniques on the above formula, P, we will obtain the following input sequence to our state transition system, where dashes indicate the input values are don't cares:

| Time | I1 | I2 | N |
|---|---|---|---|
| 0 | 1 | 0 | — |
| 1 | 0 | 1 | — |
| 2 | — | — | 1 |
| 3 | — | — | — |
| 4 | — | — | — |

These input valuations can be translated into a sequence of commands to a functional test generator such that a 2 cycle instruction, any one of that type, is generated first for a test program, then a 1 cycle instruction, any one of that type, and the variable N being true would be interpreted as a constraint to the test generator dictating that the generator should set the target of each instruction to be the same.

Further details of an exemplary implementation of the presently proposed test generation methodology or process 800 are depicted in FIG. 8 and consists of three main components: a bounded model checker (BMC) 802, a satisfiability (SAT) solver 806, and an instruction generator 810. A presently preferred BMC has been developed at Carnegie Mellon University, and a presently preferred SAT is the GRASP satisfiability solver from the University of Michigan. The model checker 802 accepts as inputs an SMV description 822 of the design's instruction set architecture (ISA) along with a CTL formula 824 specifying the safety property to check and a test length bound k 826. SMV is a description language for state transition systems and CTL is a temporal logic. It converts this input to a CNF formula 804 that is checked by GRASP for satisfiability. Satisfying assignments found by GRASP are converted into length-k instruction sequences that can be applied to a simulator 814 and run on a hardware description language implementation of the DSP core to check the validity of the specified property.

The architecture with the corresponding ISA is expressed in the SMV model by declaring the various instruction types and their arguments as input (“Free”) variables. State variables, i.e., those with a next-state update function, are used to model programmer visible architectural features, these being combinations of selected state holding bits in memories, register files, and condition flags. Additional variables are declared to simplify the use of the model, for example, to represent set of instructions, or to represent some complicated constraint on state variables. The initial value of each state variable is also declared.

Predicates representing constraints on the system can also be modeled in SMV 822. By defining a simple counter in the SMV model, restrictions on variables can be described in different time cycles. for example, to specify that variable x must be true in cycle 5 and variable y must be true in cycle 8, the following statements would be included in the SMV description:

TRANS

(cycle_{—}5−>x) &

(cycle_{—}8−>y)

where cycle_{—}5 and cycle_{—}8 are outputs of the counter.

Finally, the predicate characterizing the set of states to be reached is expressed in CTL 824. For example, in order to generate a test vector that covers a write enable state, the CTL expression:

AG ! (inst_write_enable)

is used. This expression directs BMC 402 to search the state transition system for a finite path that starts at an initial state and ends at a state where the variable inst_write_enable is true.

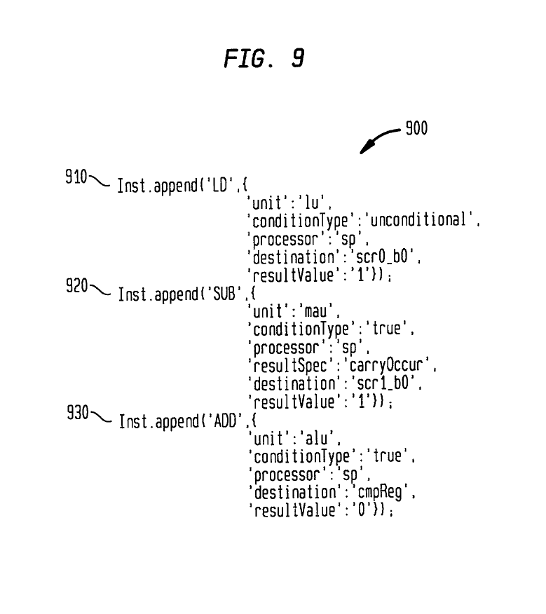

Since it is often not necessary to describe data values completely to describe the effects of instruction execution, it is often necessary to represent a few bits among the input or target values for an instruction, as needed, and to represent architectural features, such as an instruction's target destination, the execution unit chosen, or value of conditional flags produced. FIG. 9 shows an exemplary output of the process 800, describing a sequence of instruction types 900 obeying certain constraints including a load (LD) 910, subtract (Sub) 920, and addition (Add) 930. A test generator based on the underlying instruction set architecture, the BOPS 2040 shown in FIG. 1 and FIG. 2, is then used to generate an assembly language test program that has the same instruction types in sequence, and satisfies the given constrains, such as certain opcode choices, ability to set certain bits in a target register, and the like.

To evaluate the performance of the present invention, several test vector templates were generated for various properties of BOPS DSP cores. Three SMV models were created. The first model included a single SP unit that executed non-VLIW instructions only. The second model consisted of four PE units controlled by an SP unit executing non-VLIW instructions only. Finally, a model consisting of four PE units controlled by an SP and executing VLIW instructions was created. All models were described in the SMV language with several properties of instruction sequences were expressed in CTL. The SMV programs for the 3 models consisted of 3,700, 13,000 and 40,000 lines of code, respectively. The experiments were conducted on a 333 MHz Pentium II running Linux and equipped with 512 Mbyte of RAM.

In these experiments, sequences were generated with k bound values: 1, 2, 3, . . . , 9, and 10 where, for a sequence of length k, k instruction types would be generated. The k value is incremented whenever an unsatisfiable solution is returned, meaning the desired ending state cannot be reached in that value of k time steps. If a satisfiable solution is returned, the process exits and the variable assignment is converted into a valid instruction type sequence, i.e., a template. A maximum k bound of 10 levels was selected for each tested CTL instruction sequence description. It should be noted that the inventive technique guarantees the detection of the shortest set of test vectors for each property.

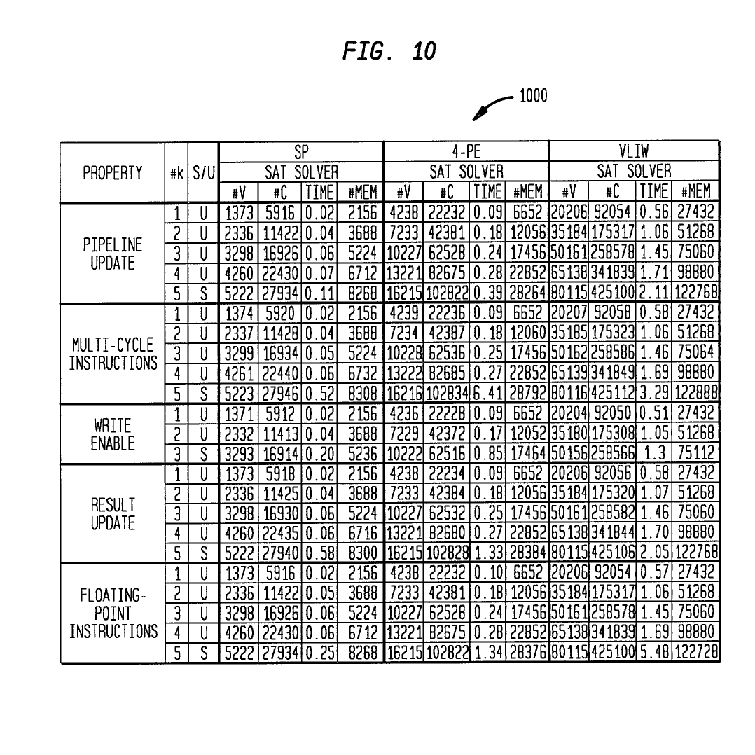

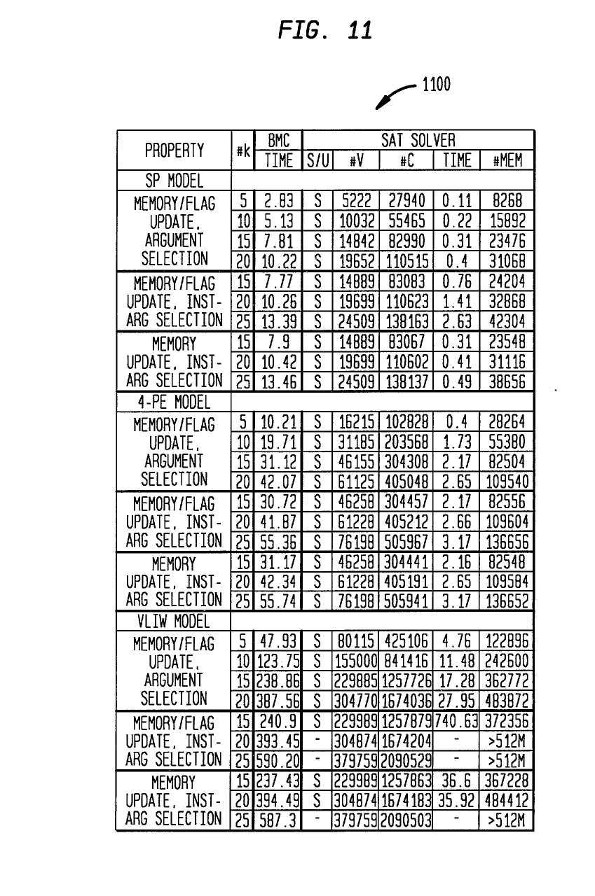

The results are shown in table 1000 of FIG. 10. In table 1000, Time represents the execution time in seconds for running BMC for k values: 1, 2, 3, . . . , 9, and 10, while V and C denote, respectively, the total number of variables and clauses in the generated CNF formula. S/U denotes whether the problem is satisfiable or unsatisfiable. #k represents the number of unfolded levels in the transition relation while #Mem denotes the amount of memory in KB used in the search process. Table 1000 shows the results for all three of the above mentioned models of the DSP core.

Several types of sequences were generated, with instances of PE masking, conditional execution, several instruction types, instruction arguments, conditional flag update scenarios, pipeline update, floating point instructions, and memory read/write transactions.

As can be seen, the proposed technique was able to represent the design consisting of an array of 4 processors executing as many as 20 instructions in parallel. Instruction sequences were constructed for most of the specifications, and most of these were only a few instructions long, and yet reached their goals. For example, a minimum sequence of three instructions is needed to test a write enable property for the SP model. An instance of such an instruction sequence, produced by our technique, is shown in FIG. 9. The first instruction is a load instruction that executes unconditionally on the 1 u unit in the SP processor. The instruction writes a value of 1 to register scr0_b0. The second instruction is a subtract instruction that executes conditionally on the MAU unit in the SP processor. The result of value 1, generates a carry, and has to be written to register scr1. Finally, the third instruction is an add instruction that also executes conditionally on the ALU unit in the SP processor. The result of value0 has to be written to register cmpReg. A test generator will take care of instantiating particular registers for cmpReg and scr1 when converting to actual test case.

Although the size of the CNF formulae were very large, the SAT solver was able to solve the problems in a few seconds since most of the clauses in any generated formula were of size 2. Smaller clauses reduce the complexity of the satisfiability solving problem and enhance the performance of the search process. BMC was able to create a CNF formula within a few seconds for all problems.

The technique was also able to generate longer test cases. Several properties at different time cycles were specified and run for k bound values: 15, 20, and 25. Table 1100 of FIG. 11 shows the results. As in the previous table 1000, Time denotes the execution time in seconds and #Mem represents the memory used in KB. Both the single processor model (SP) and the 4 processor model (PE), executing non-VLIW instructions, were able to produce longer instruction sequences in feasible times for all properties. However, due to the size of the generated CNF formula, the 4-processor model with VLIW instructions failed for some cases with larger k bounds. Nevertheless, the proposed approach can achieve a significant improvement when compared to other approaches for regular processors, and was, indeed, able most often to create long instruction sequences even for an array of 4 pipelined processors, executing up to 20 instructions in parallel.

In order to measure the difference between the BDD-based approaches and the SAT-based approaches, all 3 models were run using the BDD-based Symbolic Model Checker, SMV from Carnegie-Mellan University that takes input comprising design descriptions in a language also referred to as SMV. For each of the 3 models, SMV ran for 24 hours and was unable to compile the description of the models. In other words, it was unable to build the BDD of the transition relation. Although SMV performs a complete search of the underlying state transition system, it is believed that using bounded model checking to conduct a partial search works best for this type of problem.

The methods and apparatus described herein yield a test generation system in which the user can dictate the end results that a test program should achieve, in terms of reaching specific architectural states, and the test generation system, in a highly automated manner, can achieve these goals and can do this on systems of a size that is of interest to industry. The user does not need to know how to write an assembly language program that sequences through the architectural states of interest, this is automatically done for him or her.

While the present invention has been described in a particular context, such as evaluating BOPS processing arrays, it will be recognized that it can be adapted to other contexts, such as other processing families and the like where the complexity of the design makes the prior art approaches too inefficient or unavailing, and the presently described techniques highly desirable.

We claim:

1. An automated method of testing implementations of an instruction set architecture (ISA) comprising the steps of:
defining a finite state transition system model of the ISA;
traversing the finite state model to find a state sequence of interest; and
automatically transforming a description of the state sequence of interest to an assembly language test program wherein the step of traversing the finite state model utilizes a satisfiability solving tool (SAT)-based bounded model checker to find state transitions that reach architectural states of interest in the state sequence of interest obeying certain designated constraints.

2. The method of claim 1 wherein the step of defining the finite state model comprises the steps of:
identifying a set of state variables;
defining a present and a next state variable pair for each of said state variables; and
defining a set of input variables.

3. The method of claim 2 wherein the set of state variables comprises variables representing programmer visible features.

4. The method of claim 2 wherein the input variables comprise a set union of a set of variables representing instructions and a set of variables representing relationships among instructions.

5. The method of claim 2 further comprising the steps of:
defining a transition function for each specified state variable based on the ISA.

6. The method of claim 4 further comprising the step of:
establishing a transition relation of the model of the ISA by ANDing the transition functions together.

7. The method of claim 1 further comprising the step of:
writing predicate functions that define constraints on the programming environment of the ISA.

8. The method of claim 7 further comprising the step of ANDing the predicate functions with the transition relation functions to insure the production of state sequences that obey the constraints.

9. The method of claim 1 further comprising the step of:
specifying types of state sequences for which it is desired to determine if said sequences are possible as formulas in a temporal logic.

10. The method of claim 9 further comprising the use of SAT-based bounded model checking on the finite state transition model of the ISA to generate instruction sequence templates that satisfy the temporal logic formulas.

11. The method of claim 10 further comprising the step of:
using an instruction sequence template and the constraints as in input to using a test program generator specific to the ISA to automatically generate assembly language programs based on specified sequences of opcode types and user specified constraints.

12. The method of claim 1 further comprising the steps of:
breaking a sequence from an initial state to a final step into two sequences, a first from the initial state to a first predetermined state and a second from the first predetermined state to the final state;
utilizing the SAT-based bounded model checker to find the first and the second sequences; and
concatenating the first and the second sequences.

13. An automated system for verifying an instruction set architecture (ISA) design comprising the steps of:
means for defining a finite state transition system model of the ISA;
means for traversing the finite state model to find a state sequence of interest; and
means for automatically transforming a description of the state sequence of interest to an assembly language test program wherein the means for traversing the finite state model utilizes a satisfiability solving tool (SAT)-based bounded model checker to find state transitions that reach architectural states of interest in the state sequence of interest obeying certain designated constraints.

14. The system of claim 13 wherein the means for defining the finite state model further comprises:
means for identifying a set of state variables;
means for defining a present and a next state variable pair for each of said state variables; and
means for defining a set of input variables.

15. The system of claim 14 wherein said set of state variables comprises variables representing programmer visible features.

16. The system of claim 14 wherein the system's input variables comprise a set union of a set of variables representing instructions and a set of variables representing relationships among instructions.

17. The system of claim 14 further comprising:
means for defining a transition function for each specified state variable based on the ISA.

18. The system of claim 17 further comprising:
means for establishing a transition relation of the model of the ISA by ANDing the transition functions together.

19. The system of claim 13 further comprising:
means for writing predicate functions that define constraints on the programming environment of the ISA.

20. The system if claim 13 further comprising means for ANDing the predicate functions with the transition relation functions to insure the production of state sequences that obey the constraints.

21. The system of claim 13 further comprising:
means specifying types of state sequences for which it is desired to determine if said sequences are possible as formulas in a temporal logic.

22. The system of claim 21 further comprising a SAT-based bounded model checking tool to generate instruction sequence templates that satisfy the temporal logic formulas based on the finite state transition model of the ISA.

23. The system of claim 13 further comprising:
a test program generator specific to the ISA to automatically generate assembly language programs based on specified sequences of opcode types and user specified constraints.

24. The system of claim 13 further comprising:
means for breaking a sequence from an initial state to a final step into two sequences, a first from the initial state to a first predetermined state and a second from the first predetermined state to the final state;
the SAT-based bounded model checker further operable to find the first and the second sequences; and
means for automatically concatenating the first and the second sequences.
